(19) United States
(12) Patent Application Publication
(10) Pub. No.: US 2026/0153386 A1
(43) Pub. Date: Jun. 4, 2026

(54) MEASURING ASSEMBLY

(71) Applicant: ebm-papst Mulfingen GmbH & Co. KG, Mulfingen (DE)

(72) Inventor: Sebastian SCHROTH, Kupferzell (DE)

(21) Appl. No.: 18/707,665

(22) PCT Filed: Oct. 28, 2022
(86) PCT No.: PCT/EP2022/080244

§ 371 Date: May 6, 2024

(30) Foreign Application Priority Data
Nov. 4, 2021 (DE) 10 2021 128 668.9

(51) Int. Cl. G01K 7/16

(52) U.S. Cl. CPC G01K 7/16

(57) ABSTRACT

The present disclosure relates to a measuring assembly having a measuring circuit, which is arranged on or in an electrical machine, and an evaluation unit, which is arranged outside the electrical machine and is connected to one of the phases of the electrical machine. The electrical connections of the phase that are present anyway are used for this. The measuring circuit has a sensor, which can change its sensor value continuously or in stages as a function of a parameter to be measured. The sensor is coupled to a coupling branch of the measuring circuit, which coupling branch is in turn coupled to one of the windings of the phase. The measuring circuit is configured to influence a coupling branch impedance of the coupling branch as a function of the sensor value and therefore of the parameter, as a result of which the total impedance of the phase changes. The influence of the total impedance can be detected by the evaluation unit. In this way, a signal describing the parameter can be transmitted to the evaluation unit via the electrical connections of the phase.

### CROSS REFERENCE TO RELATED APPLICATIONS

This application is a National Stage of PCT Application No. PCT/EP2022/080244 filed on Oct. 28, 2022, which claims priority to German Patent Application No. 10 2021 128 668.9 filed on Nov. 4, 2021, the contents each of which are incorporated herein by reference thereto.

### TECHNICAL FIELD

The present disclosure refers to a measuring assembly for an electric machine, particularly an electric motor. In embodiments a brushless DC-motor (BLDC) or also a synchronous machine can be used as electric motor. Basically, the present disclosure is also suitable for other electrical machines. The electrical machine is controlled by means of a control device. The control device can comprise, for example, an inverter or converter in order to adjust a phase current and/or a phase voltage for each present phase.

### BACKGROUND

DE 10 2016 106 431 A1 describes a measuring assembly comprising multiple two-terminal networks having a capacitance and a temperature-dependent impedance in each case. The two-terminal networks are connected in parallel to the phases in an electrical machine. The electric motor is controlled by means of a frequency converter. Additional lines for connecting the two-terminal networks are not necessary. When the current through one of the motor phases is switched on, the current response is influenced in a temperature-dependent manner due to the temperature-dependent impedance of the two-terminal network connected in parallel to the motor phase and can be evaluated in order to determine the temperature at the installation site of the two-terminal network.

A measuring method for determination of the winding temperature of a motor winding of an electric motor is known from DE 10 2017 108 112 A1. For this purpose, the motor winding is excited by means of a high-frequency oscillation and a resonance oscillation is produced. The resulting resonance frequency is determined and the winding temperature is calculated from the resonance frequency.

### BRIEF SUMMARY

Starting from the prior art, a measuring assembly for determination of a parameter to be determined shall be provided, which allows a measurement value transmission to a control device without additional transmission lines.

This object is solved by means of a measuring assembly for an electrical machine, including: at least one phase of the electrical machine comprising at least one winding, a measuring circuit comprising a coupling branch coupled with the at least one winding and a sensor coupled with the coupling branch, wherein the measuring circuit is configured to influence a coupling branch impedance of the coupling branch depending on a parameter to be measured by means of the sensor.

The measuring assembly serves to detect a parameter to be measured at or in an electrical machine, for example a temperature, a humidity of a surrounding atmosphere, an acceleration in at least one spatial direction, another physical parameter or an arbitrary combination of multiple of the indicated parameters. The electrical machine can be an electric motor in an embodiment. For example, brushless DC-motors (BLDC) or synchronous motors can be used as electric motor. The electrical machine is preferably controlled by means of a control device, which can comprise an inverter or converter or another suitable control circuit, for example. Particularly, the control device is configured to create a rotating stator magnetic field. The control device can have a control output for each present phase of the electrical machine, wherein the control output is electrically connected by means of a control line with the respectively assigned phase of the electrical machine.

Each phase of the electrical machine comprises at least one, preferably at least two windings connected in series. Each winding is particularly arranged around a tooth of the stator and configured to create a substantially radially orientated magnetic field, particularly a stator magnetic field.

The measuring assembly comprises a measuring circuit. The measuring circuit has a coupling branch and a sensor coupled with the coupling branch. The sensor is configured to modify a sensor value depending on the parameter to be measured. The sensor value is thus available for the measuring circuit that is configured to influence a coupling branch impedance of the coupling branch depending on the sensor value and thus depending on the parameter to be measured. For example, the coupling branch impedance can be varied between two or more conditions, such as between a conducting and a blocking condition or in general between conditions with different coupling branch impedances. The coupling branch is coupled with at least one or exactly one of the windings of one of the present phases without galvanic connection (for example inductively) or with galvanic connection connected in parallel to the at least one or the exactly one winding of the phase. Preferably, the coupling branch can be realized without galvanic connection to the at least one winding and thus without galvanic connection to the electrical machine.

Independent from the type of coupling or connection, the coupling branch impedance that can be influenced by the parameter to be measured, influences the total impedance of the phase. Thereby at least temporal changes of electrical parameters can be produced that in turn can be detected at the electrical connections of the phase. An evaluation unit can detect and evaluate the at least one variable electrical parameter at the anyhow present electrical connections of the phase. The measuring circuit can modify the respective electrical parameter at least temporarily, so that data or information can be transmitted to the evaluation unit, which particularly describe the sensor value. Thus, a sensor value or the value of the parameter to be measured can be transmitted. The phase is therefore, apart from the creation of a magnetic field in the electrical machine, also used for data transmission by means of the measuring assembly according to the present disclosure.

The at least one variable electrical parameter can comprise one or more of the following parameters, for example:
a phase position of the phase current compared to the phase voltage for the phase and/or
a gradient of the phase current during switching the phase current on and/or off and/or
an absolute value of the phase current and/or an absolute value of the phase voltage of the respective phase and/or
a total impedance of the phase or an electrical parameter correlated therewith.

Due to the change of the total impedance of the phase, multiple effects can be produced that can be detected in turn. For example, the rotational speed can be changed (for example reduction of the rotational speed by reducing the total impedance), the inductance of the phase can be changed and/or also the symmetry relations between the present phases can be changed.

The measuring assembly can switch its condition or its coupling branch impedance also between two or multiple values or absolute values in a modulating manner, so that for example, multiple sensor values or more complex data or information can be transmitted via the phase out of the electrical machine in a simple manner.

The measuring assembly can also comprise multiple measuring circuits. The latter can be assigned to different phases or different windings.

It is advantageous if the sensor of the measuring circuit is arranged in the coupling branch so that a simple change of the coupling branch impedance is possible by means of the sensor value. For example, the sensor can be a resistor that is variable depending on the parameter to be measured or can comprise such a resistor. The sensor can also be configured as switching sensor, which establishes a conducting connection if the parameter to be detected exceeds a threshold and which blocks the electrical path through the coupling branch if the parameter to be detected drops below the same threshold or another threshold (switching sensor with or without hysteresis). For example, the sensor is connected in series or parallel to the coupling branch impedance or is part of the coupling branch impedance in these embodiments.

Preferably, the coupling branch impedance of the coupling branch has an ohmic component and/or an inductive component. It is preferred, if the coupling branch impedance does not comprise a capacitive component. In doing so, it can be guaranteed that the phase current of the phase does not precede. In a preferred embodiment the ohmic component of the coupling branch impedance predominates. For example, the capacitive component as well as the inductive component can be respectively maximum 10% or respectively maximum 5% in relation to the total amount of the coupling branch impedance. Particularly, the capacitive component as well as the inductive component can be negligibly small.

The measuring circuit can maintain the coupling branch in a condition in which the branch current through the coupling branch is smaller than the phase current through the at least one phase coupled with the coupling branch as long as the parameter to be measured is within a non-critical range. For example, the branch current can be maximum 10% or maximum 5% of the phase current as long as the parameter to be measured is within a non-critical range. A non-critical value range for the parameter to be measured can be predefined or set.

In an embodiment the measuring circuit can comprise a switch that can be switched between a conducting condition and a blocking condition by means of a control signal. The switch is preferably arranged in the coupling branch. The switch can be a controllable semi-conductor switch, for example a field effect transistor or bipolar transistor.

The measuring circuit can be configured to produce the control signal for the switch depending on the sensor value or depending on the parameter to be measured. For example, the control signal can create a switching of the switch upon reaching a threshold for the sensor value or the parameter to be measured (with or without hysteresis between switching in the conducting condition and switching in the blocking condition). The control signal can, however, also transmit more complex information, for example multiple sensor values, and can switch the switch between the conducting and the blocking condition for encoding. In this manner information can be transmitted by means of modulation or encoding.

In an embodiment the coupling branch can comprise an additional winding around at least one and preferably exactly one tooth of the electrical machine. In doing so, an inductive coupling between the additional winding of the coupling branch and the at least one winding of the phase of the electrical machine arranged on the tooth can be achieved.

For example, the tooth is part of the stator of the electrical machine. For each winding of a phase a separate tooth can be provided. The additional winding can have one single winding loop or multiple winding loops. Preferably, the number of winding loops of the additional winding is remarkably lower (for example at least two to three times lower) than the number of winding loops of the phase winding connected in parallel.

The measuring circuit can thus be an integral part of the electrical machine, however, thereby done without galvanic connection to the electrical machine. Apart from the additional winding, other components of the measuring circuit can be arranged on a common support, for example a common circuit board, that is arranged adjacent to the tooth or the winding of the phase on or in the electrical machine.

### BRIEF DESCRIPTION OF THE DRAWINGS

Advantageous embodiments of the present disclosure are derived from the dependent claims, the description and the drawings. In the following, preferred embodiments are explained in detail based on the attached drawings. The drawings show:

FIG. 1 a block diagram of an electrical machine controlled by means of a control device and comprising a measuring assembly,

FIGS. 2 and 3 an electrical block diagram or equivalent circuit of an electrical phase of the electrical machine of FIG. 1 respectively having an embodiment of a measuring circuit respectively,

FIG. 4 a schematic illustration of an embodiment of an electrical machine with view along a rotation axis, wherein a measuring circuit is arranged on a tooth and

FIG. 5 a vector diagram for illustration of the phase shift between a phase voltage and a phase current through a phase of the electrical machine.

### DETAILED DESCRIPTION

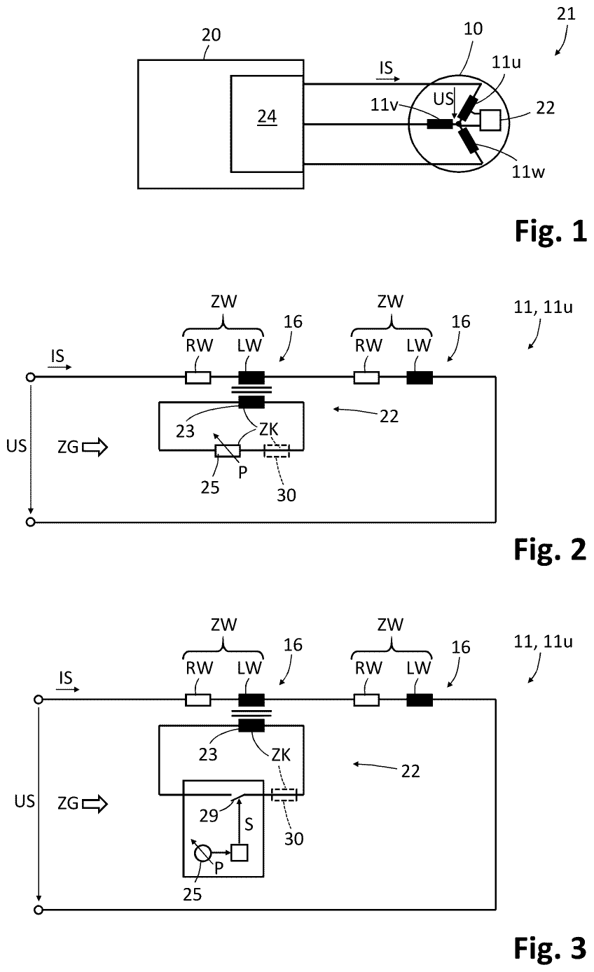

FIG. 1 shows a block diagram of an electrical machine 10 comprising multiple phases 11, for example a first phase 11u, a second phase 11v and a third phase 11w. If for the phase the reference sign 11 is used without additional letter characterization, the indications apply for multiple or all phases 11u, 11v, 11w.

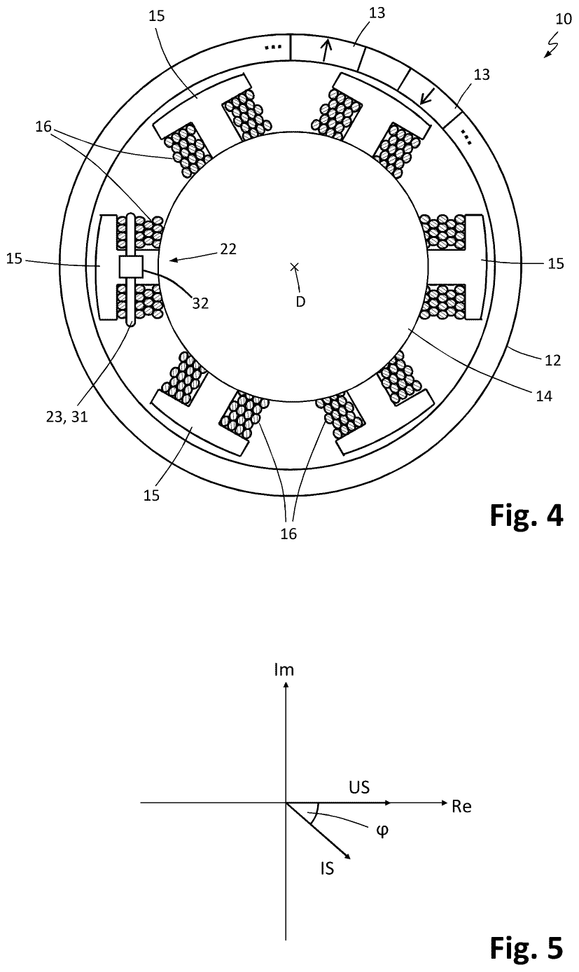

The electrical machine 10 can be an electric motor, for example, such as a brushless DC-motor or a synchronous machine. An embodiment of a brushless DC-motor is shown in FIG. 4 only by way of example and schematically. On a rotor 12 rotatable around a rotation axis D, permanent magnets 13 are arranged distributed in circumferential direction, which can be magnetized in circumferential direction around the rotation axis D, for example. A stator 14 of the electrical machine 10 has teeth 15 distributed in circumferential direction around the rotation axis D, wherein only exemplarily six teeth 15 are illustrated in the embodiment. The number of teeth 15 can also be larger, for example 12. The number of teeth 15 is particularly even.

At each tooth 15 at least one or exactly one winding 16 is arranged. In the illustrated embodiment each phase 11 comprises two windings 16, wherein the number of windings 16 of each phase 11 can also be lower or higher. The windings 16 arranged opposite relative to the rotation axis D, according to the example, are part of a common phase 11. The windings 16 are connected in series to one another. In the equivalent circuit diagram each winding 16 can be formed by means of a series connection of a winding resistance RW and a winding inductance LW. The winding resistance RW is thereby an ohmic resistance. For the winding impedance ZW of each winding 16 applies:

$$Z W = R W + j ω L W \qquad ( 1 )$$

wherein ω represents the angular frequency and j represents the imaginary component.

The electrical machine 10 is controlled by means of a control device 20. The control device 20 is configured to individually adjust a phase voltage US and/or a phase current IS for the respectively assigned first phase 11u, second phase 11v and third phase 11w. Thereby particularly a stator magnetic field rotating around rotation axis D can be produced in order to rotate the rotor 12, provided with permanent magnets 13, around the rotation axis D. For this purpose, the control device 20 can comprise an inverter circuit, for example.

The electrical machine 10 is equipped with a measuring assembly 21. The measuring assembly 21 has at least one measuring circuit 22 assigned to one of the phases 11 and according to the example to the first phase 11u. The measuring circuit 22 could also be assigned to one of the other phases 11v, 11w. The measuring circuit 22 is only highly schematically illustrated in FIGS. 1 and 4.

As particularly apparent from FIGS. 2 and 3, the measuring circuit 22 comprises a coupling branch 23 coupled with one of the windings 16. According to the example, the coupling branch 23 is coupled without galvanic connection with the at least one winding 16. Alternatively to this, the coupling branch could also be connected galvanically parallel to the at least one winding 16. Therefore, by means of the coupling branch 23 a total impedance ZG of the respective phase 11 (for example the first phase 11u) can be influenced. The coupling branch 23 has a coupling branch impedance ZK, which can be varied. For the total impedance ZG of the phase 11 it generally applies:

$$Z G = Z W + \frac{ZW \cdot ZK}{Z W + Z K} \qquad ( 2 )$$

The total impedance ZG or an electrical parameter influenced by the total impedance ZG, for example the phase current IS and/or the phase voltage US, can be detected by means of an evaluation unit 24 of the control device 20. The evaluation unit 24 of control device 20 is part of the measuring assembly 21 in the embodiment. In a modified embodiment the evaluation unit 24 could also be arranged as individual component separate from control device 20 and could be connected to the control lines leading to the phases 11.

In addition, measuring circuit 22 has a sensor 25, the sensor value of which varies depending on a parameter P to be measured. For example, the sensor 25 can be a variable resistor, the resistance value of which changes depending on the parameter P. For example, the sensor can be a temperature-dependent resistor if the temperature shall be measured as parameter P. The sensor 25 can also comprise a switching characteristic according to which it changes its resistance value or conductivity value depending on the parameter P between two or more conditions in a step-like manner, for example between a low ohmic conductive condition and a blocking condition. For this purpose, sensor 25 can comprise a semi-conductor, for example, which can take at least two different conditions, such as a diode, a transistor or a thyristor or alternatively another switch, for example a bimetal switch.

Additionally or alternatively to the temperature T, also another physical parameter can be measured as parameter P, for example the humidity in the surrounding atmosphere or an acceleration in at least one spatial direction. The sensor 25 can also detect an arbitrary combination of different parameters P.

In the embodiment illustrated in FIG. 2, sensor 25 is arranged in the coupling branch 23. The sensor 25 is configured to vary its resistance value depending on the parameter P, either stepwise between at least two steps or according to a continuous characteristic. Thereby the coupling branch impedance ZK, which is in the embodiment substantially or exclusively formed by the impedance of sensor 25, varies depending on the parameter P to be measured. Consequently, also the total impedance ZG varies depending on the parameter P to be measured. This variation can be detected by means of the evaluation unit 24. It is therefore possible to transmit the parameter P to be measured to the evaluation unit 24 or the control device 20 via the electrical connections of the phase 11 (here: first phase 11u).

An additional impedance 30 can optionally be connected in series to the sensor 25 in the embodiment according to FIG. 2.

The configuration of the measuring circuit 22 can vary. An additional embodiment is illustrated in FIG. 3. There the measuring circuit 22 comprises a switch 29 that can be controlled by means of a control signal S. The switch 29 can take a conductive condition or a blocking condition depending on the control signal S. The switch 29 can be realized, for example, by using a semi-conductor switch, particularly a bipolar transistor or a field effect transistor. Thus, the parallel current path through the coupling branch 23 can be completely blocked or deblocked depending on the switching condition of the switch 29. As an option, in series to the switch 29 an additional impedance 30 can be connected comprising an ohmic resistance and/or an inductance, which then substantially defines the coupling branch impedance ZK in the conducting condition of switch 29.

In the embodiment illustrated in FIG. 3 the measuring circuit 22 is configured to produce the control signal S depending on the sensor value of sensor 25 and thus depending on the parameter P to be measured. In a simple case, therefore, by switching switch 29 using control signal S it can be indicated, for example, that the sensor value or the parameter P has exceeded a predefined threshold. Alternatively to this, the control signal S can also switch the switch 29 between the conducting and the blocking condition according to a predefined modulation or a predefined code, so that by means of binary coding or modulation, more complex information, for example arbitrary sensor values or values for the parameter P to be measured, can be transmitted to the evaluation unit 24. In the evaluation unit 24 by means of demodulation or decoding, the value for the parameter P to be measured can be restored. In this manner a series transmission of a bit sequence to the evaluation unit 24 can be carried out, for example.

As apparent from FIG. 3, in this embodiment sensor 25 can be arranged external from coupling branch 23 and can be indirectly connected with the coupling branch and according to the example, the controllable switch 29.

By varying the total impedance ZG depending on parameter P, one or more of the following electrical parameters can be influenced that can be detected by evaluation unit 24 in order to obtain the transmitted value for the parameter P to be measured:
the absolute value of the phase current IS and/or the phase voltage US;
the total impedance ZG or inductance of the phase 11 to which the measuring circuit 22 is coupled;
the gradient of the phase current IS upon application of a phase voltage US to the respective phase 11;
a phase shift q between the phase voltage US and the phase current IS;
the behavior of the electrical machine 10 during application of an alternating voltage as phase voltage US, particularly a high-frequency alternating voltage.

Additionally or alternatively to the at least one electrical parameter, also other physical parameters can be determined by means of the evaluation unit, for example the rotational speed of the electrical machine, which can change depending on the total impedance ZG.

As illustrated schematically in FIG. 4, the coupling branch 23 of measuring circuit 22 can comprise an additional winding 31 or can be formed by an additional winding 31, which can be arranged on tooth 15 supporting the winding 16 of the assigned phase 11, for example the first phase 11u, that is coupled with the coupling branch 23. The additional winding 31 can have one or more winding loops. On the additional winding 31 a support 32 can be arranged and mechanically and electrically connected with the additional winding 31. The support 32 can be configured as circuit board, for example. On the support 32 additional components and preferably all of the additional components of the measuring circuit 22 can be arranged (compare FIGS. 3 and 4).

The present disclosure refers to a measuring assembly 21 comprising a measuring circuit 22, which is arranged on or in an electrical machine 10, as well as an evaluation unit 24, which is arranged outside the electrical machine 10 and is connected with one of the phases 11 of the electrical machine 10. For this purpose, the electrical connections of the phase 11 are used that are present anyhow. A measuring circuit 22 has a sensor 25 that can vary its sensor value depending on a parameter P to be measured continuously or in steps. The sensor 25 is coupled with a coupling branch 23 of the measuring circuit 22 that in turn is coupled with one of the windings 16, preferably of one single phase 11, preferably without galvanic connection to the winding 16, for example inductively. The measuring circuit 22 is configured to influence a coupling branch impedance ZK of coupling branch 23 at least temporarily depending on the sensor value and thus the parameter P, whereby the total impedance ZG of the phase 11 varies. The influence of the total impedance ZG can be detected by the evaluation unit 24. In this manner, a transmission of a signal describing the parameter P to the evaluation unit 24 via the electrical connections of the phase 11 can be carried out.

### LIST OF REFERENCE SIGNS

10 electrical machine
11 phase
11u first phase
11v second phase
11w third phase
12 rotor
13 permanent magnet
14 stator
15 tooth
16 winding
20 control device
21 measuring assembly
22 measuring circuit
23 coupling branch
24 evaluation unit
29 sensor
29 switch
30 additional impedance
31 additional winding
32 support
φ phase shift
D rotation axis
IS phase current
LW winding inductance
P parameter
RW winding resistance
S control signal
US phase voltage
ZG total phase impedance
ZK coupling branch impedance
ZW winding impedance

1. A measuring assembly for an electrical machine, comprising:
at least one phase of the electrical machine comprising at least one winding,
a measuring circuit comprising a coupling branch coupled with the at least one winding and a sensor coupled with the coupling branch, wherein the measuring circuit is configured to influence a coupling branch impedance of the coupling branch depending on a parameter to be measured by means of the sensor.

2. The measuring assembly according to claim 1, wherein each phase of the electrical machine comprises a series connection of at least two windings.

3. The measuring assembly according to claim 1, wherein the sensor is arranged in the coupling branch.

4. The measuring assembly according to claim 1, wherein the sensor comprises a resistance depending on the parameter to be measured.

5. The measuring assembly according to claim 1, wherein the coupling branch comprises a coupling branch impedance having an ohmic component and/or an inductive component.

6. The measuring assembly according to claim 4, wherein the coupling branch impedance does not comprise a capacitive component.

7. The measuring assembly according to claim 1, wherein the measuring circuit comprises a switch that can be switched by means of a control signal between a conductive and a blocking condition.

8. The measuring assembly according to claim 6, wherein the measuring circuit is configured to create a control signal depending on the parameter to be measured by means of the sensor.

9. The measuring assembly according to claim 1, wherein the coupling branch is coupled with the at least one winding in a galvanically isolated manner.

10. The measuring assembly according to claim 9, wherein the coupling branch comprises an additional winding by means of which the coupling branch is inductively coupled with the at least one winding.

11. The measuring assembly according to claim 10, wherein the additional winding is arranged around a tooth of the electrical machine on which the at least one winding is arranged that is coupled to the coupling branch.

12. The measuring assembly according to claim 1, further comprising in addition a control device, which is configured to control a phase current and/or a phase voltage for the at least one phase of the electrical machine.

13. The measuring assembly according to claim 1, further comprising an evaluation unit that is configured to determine a total impedance, which is formed by the coupling branch impedance of the coupling branch and a winding impedance of the at least one winding connected in parallel thereto.

14. The measuring assembly according to claim 12, further comprising an evaluation unit that is configured to determine a total impedance, which is formed by the coupling branch impedance of the coupling branch and a winding impedance of the at least one winding connected in parallel thereto, wherein the evaluation unit is part of the control device.

15. The measuring assembly according to claim 2, wherein the sensor is arranged in the coupling branch.

16. The measuring assembly according to claim 15, wherein the sensor comprises a resistance depending on the parameter to be measured.

17. The measuring assembly according to claim 16, wherein the coupling branch comprises a coupling branch impedance having an ohmic component and/or an inductive component.

18. The measuring assembly according to claim 17, wherein the coupling branch impedance does not comprise a capacitive component.

19. The measuring assembly according to claim 18, wherein the measuring circuit comprises a switch that can be switched by means of a control signal between a conductive and a blocking condition.

20. The measuring assembly according to claim 19, wherein the measuring circuit is configured to create a control signal depending on the parameter to be measured by means of the sensor.
